(19) United States
(12) Patent Application Publication
(10) Pub. No.: US 2024/0015396 A1
(43) Pub. Date: Jan. 11, 2024

(54) IMAGE CAPTURING APPARATUS CAPABLE OF AUTOMATICALLY SWITCHING BETWEEN RESPECTIVE IMAGE CAPTURING MODES SUITABLE FOR IMAGE CAPTURING ABOVE WATER SURFACE AND IMAGE CAPTURING UNDER WATER SURFACE, METHOD OF CONTROLLING IMAGE CAPTURING APPARATUS, AND STORAGE MEDIUM

(71) Applicant: CANON KABUSHIKI KAISHA, Tokyo (JP)

(72) Inventors: Masayoshi SHIBATA, Kanagawa (JP); Hidetoshi Kei, Tokyo (JP); Takashi Yoshida, Kanagawa (JP)

(21) Appl. No.: 18/349,313

(22) Filed: Jul. 10, 2023

(30) Foreign Application Priority Data
Jul. 11, 2022 (JP) 2022-111294

(51) Int. Cl. H04N 23/667; H04N 23/90; H04N 23/51; H04N 23/60

(52) U.S. Cl. CPC H04N 23/667; H04N 23/90; H04N 23/51; H04N 23/64

(57) ABSTRACT

An image capturing apparatus used for image capturing in a state floating on a water surface, includes a first camera and a second camera that capture images, a float that generates a buoyant force for positioning one of the first and second cameras above the water surface and positioning the other under the water surface, a posture detection section that detects a vertical direction of the image capturing apparatus in the floating state, and central controllers that control the first and second cameras. Each central controller switches one of the first and second cameras, positioned above the water surface, to a first image capturing mode suitable for above-water image capturing, and the other positioned under the water surface to a second image capturing mode suitable for underwater image capturing, based on a result of detection performed by the posture detection section.

### BACKGROUND OF THE INVENTION

### Field of the Invention

The present invention relates to an image capturing apparatus that is capable of automatically switching between respective image capturing modes suitable for image capturing above a water surface and image capturing under the water surface, a method of controlling the image capturing apparatus, and a storage medium.

### Description of the Related Art

There is a case where a user desires to use a digital camera for underwater image capturing. In this case, the user can perform image capturing by sealingly housing the digital camera in a waterproof case. Further, it is preferable that a digital camera used for both of above-water image capturing (image capturing above a water surface) and underwater image capturing (image capturing under the water surface) is configured such that the digital camera can be switched between a first image capturing mode suitable for above-water image capturing and a second image capturing mode suitable for underwater image capturing. In view of this point, Japanese Laid-Open Patent Publication (Kokai) No. 2003-98587 discloses a configuration in which an image capturing mode is automatically switched according to whether or not an image capturing apparatus has been housed in a waterproof case (waterproof pack). In the image capturing apparatus described in Japanese Laid-Open Patent Publication (Kokai) No. 2003-98587, when the image capturing apparatus enters a state housed in the waterproof case (hereinafter referred to as the “housed state”), the image capturing mode is switched from the first image capturing mode to the second image capturing mode. Further, when the image capturing apparatus enters a state taken out from the waterproof case, the image capturing mode is switched from the second image capturing mode to the first image capturing mode.

However, when the image capturing apparatus described in Japanese Laid-Open Patent Publication (Kokai) No. 2003-98587 is in the housed state, even if it is desired to switch the image capturing mode from the second image capturing mode to the first image capturing mode, it is difficult to perform this switching. Therefore, in a case where image capturing is performed above water using the image capturing apparatus in the housed state, image quality correction suitable for underwater image capturing is performed on an image obtained by the image capturing thus performed, which can undesirably change the image into an image against the user's intention.

### SUMMARY OF THE INVENTION

The present invention provides an image capturing apparatus that is capable of automatically switching between a first image capturing mode suitable for image capturing above a water surface and a second image capturing mode suitable for image capturing under the water surface, as required, a method of controlling the image capturing apparatus, and a storage medium.

In a first aspect of the present invention, there is provided an image capturing apparatus that is used for image capturing in a floating state in which the image capturing apparatus floats on a water surface, including a first image capturing section configured to capture an image, a second image capturing section configured to capture an image, a float configured to create a buoyant force for positioning, out of the first image capturing section and the second image capturing section, one image capturing section above the water surface and the other image capturing section under the water surface, when the image capturing apparatus is in the floating state, a detection section configured to detect a vertical direction of the image capturing apparatus in the floating state, and a controller configured to control the first image capturing section and the second image capturing section, wherein the controller switches, out of the first image capturing section and the second image capturing section, the one image capturing section positioned above the water surface to a first image capturing mode suitable for image capturing above the water surface, and the other image capturing section positioned under the water surface to a second image capturing mode suitable for image capturing under the water surface, based on a result of detection performed by the detection section.

In a second aspect of the present invention, there is provided a method of controlling an image capturing apparatus that is used for image capturing in a floating state in which the image capturing apparatus floats on a water surface, the image capturing apparatus including a first image capturing section configured to capture an image, a second image capturing section configured to capture an image, a float configured to create a buoyant force for positioning, out of the first image capturing section and the second image capturing section, one image capturing section above the water surface and the other image capturing section under the water surface, when the image capturing apparatus is in the floating state, a detection section configured to detect a vertical direction of the image capturing apparatus in the floating state, and a controller configured to control the first image capturing section and the second image capturing section, the method including switching, by control of the controller, out of the first image capturing section and the second image capturing section, the one image capturing section positioned above the water surface to a first image capturing mode suitable for image capturing above the water surface, and the other image capturing section positioned under the water surface to a second image capturing mode suitable for image capturing under the water surface, based on a result of detection performed by the detection section.

According to the present invention, it is possible to automatically switch between the first image capturing mode suitable for image capturing above the water surface and the second image capturing mode suitable for image capturing under the water surface, as required.

Further features of the present invention will become apparent from the following description of exemplary embodiments (with reference to the attached drawings).

### BRIEF DESCRIPTION OF THE DRAWINGS

FIG. 1 is an exploded perspective view of a camera system according to an embodiment of the present invention.

FIG. 2A is an appearance perspective view of the camera system shown in FIG. 1.

FIG. 2B is an appearance side view of the camera system shown in FIG. 1.

FIG. 3A is an appearance perspective view of a first camera included in the camera system shown in FIG. 1, as viewed from above.

FIG. 3B is an appearance side view of the first camera included in the camera system shown in FIG. 1.

FIG. 3C is an appearance perspective view of the first camera included in the camera system shown in FIG. 1, as viewed from below.

FIG. 4 is a view showing an example of a use state of the camera system shown in FIG. 1.

FIG. 5 is a block diagram showing a hardware configuration of the camera system shown in FIG. 1.

FIG. 6A is a flowchart of a process performed by the camera system shown in FIG. 1.

FIG. 6B is a continuation of FIG. 6A.

FIG. 7 is a diagram showing a relationship between images captured by the camera system shown in FIG. 1 and images displayed on a smartphone.

### DESCRIPTION OF THE EMBODIMENTS

The present invention will now be described in detail below with reference to the accompanying drawings showing embodiments thereof. However, the following description of configurations of the embodiments is given only by way of example, and is by no means intended to limit the scope of the present invention. For example, components of the present invention can be replaced by desired components which can exhibit the same functions. Further, desired components may be added.

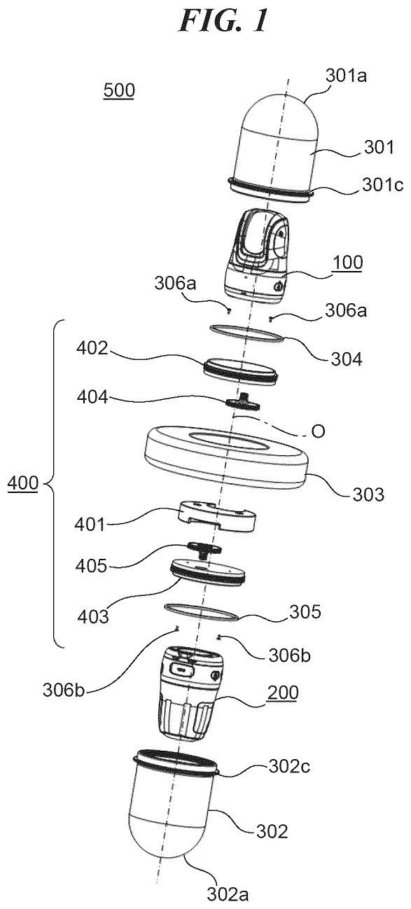

FIG. 1 is an exploded perspective view of a camera system according to an embodiment of the present invention. The camera system (image capturing apparatus), denoted by reference numeral 500, shown in FIG. 1, is used for image capturing in a state floating on the water surface (hereinafter referred to as the “floating state”). The camera system 500 includes a first camera 100 as a first image capturing unit, a second camera 200 as a second image capturing unit, and an intermediate member 400 as a fixing portion for fixing the first image capturing unit and the second image capturing unit. Further, the camera system 500 includes a waterproof case (first waterproof case) 301 for housing the first camera 100, a waterproof case (second waterproof case) 302 for housing the second camera 200, and a float 303 disposed between the first waterproof case 301 and the second waterproof case 302. In the floating state of the camera system 500, one of the first camera 100 (first image capturing section) and the second camera 200 (second image capturing section) is used for above-water image capturing, and the other is used for underwater image capturing. Note that in the present embodiment, cameras having the same configuration, i.e. the same cameras are used as the first camera 100 and the second camera 200, and these cameras are arranged in a state vertically inverted from each other.

The intermediate member 400 is formed by a middle base 401 in the form of a disk, a bottom base 402 in the form of a disk, a bottom base 403 in the form of a disk, a fixing screw 404, and a fixing screw 405. The bottom base 402 is fixed to an upper side of the middle base 401, as viewed in FIG. 1, with a plurality of fastening screws 306a. The first camera 100 is fixed to the bottom base 402 with the fixing screw 404. The bottom base 403 is fixed to a lower side of the middle base 401, as viewed in FIG. 1, with a plurality of fastening screws 306b. The second camera 200 is fixed to the bottom base 403 with the fixing screw 405. Using the intermediate member 400 configured as described above, it is possible to fix the first camera 100 and the second camera 200 in a state disposed on opposite sides of the intermediate member 400, i.e. in a state arranged at respective vertically opposite locations. Further, the first camera 100 and the second camera 200 are arranged vertically symmetrically with respect to the intermediate member 400 (float 303).

Further, the waterproof case 301 is removably attached to the bottom base 402 e.g. by screwing the former onto the latter. An O ring 304 is held between the bottom base 402 and the waterproof case 301 in a compressed state. This makes it possible to prevent water from entering from between the bottom base 402 and the waterproof case 301, and therefore, it is possible to protect the first camera 100 from water. The waterproof case 302 is removably attached to the bottom base 403 e.g. by screwing the former onto the latter. An O ring 305 is held between the bottom base 403 and the waterproof case 302 in a compressed state. This makes it possible to prevent water from entering from between the bottom base 403 and the waterproof case 302, and therefore, it is possible to protect the second camera 200 from water.

The waterproof case 301 has a hollow cylindrical shape, with an upper end wall portion 301a formed into a rounded dome-like shape, and the first camera 100 is housed and disposed inside the waterproof case 301. The waterproof case 301 is transparent enough to enable image capturing using the first camera 100. The waterproof case 302 has a hollow cylindrical shape, with a lower end wall portion 302a formed into a rounded dome-like shape, and the second camera 200 is housed and disposed inside the waterproof case 302. The waterproof case 302 is transparent enough to enable image capturing using the second camera 200. Further, the waterproof case 301 and the waterproof case 302 are arranged at respective locations where the respective center lines of the waterproof case 301 and the waterproof case 302 coincide with a virtual line O connecting between the centers of the first camera 100 and the second camera 200. The float 303 is disposed between the waterproof case 301 and the waterproof case 302, i.e. at a vertically central location of the camera system 500. The float 303 has an annular shape with the virtual line O as the center. The float 303, when in the floating state, generates a buoyant force for positioning one of the first camera 100 and the second camera 200 above the water surface and the other under the water surface. Combined with the arrangement of the first camera 100 and the second camera 200 vertically symmetrical with respect to the intermediate member 400, the buoyant force makes the posture of the camera system 500 stable in the floating state. With this, it is possible to use one of the cameras, positioned above water, for above-water image capturing, and use the other, positioned under water, for underwater image capturing. Note that the configuration for generating the buoyant force is not particularly limited, and for example, there may be used a configuration in which the float 303 is formed of a foamed material or the like and the center of gravity of the float 303 is positioned to the center of the camera system 500 to the extent possible.

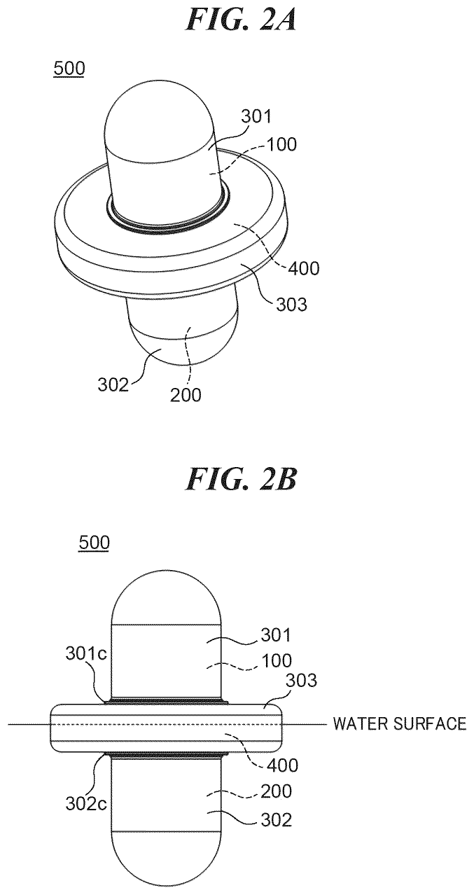

FIGS. 2A and 2B are appearance views of the camera system 500 shown in FIG. 1. FIG. 2A is an appearance perspective view, and FIG. 2B is an appearance side view. The waterproof case 301 and the waterproof case 302 are removably attached to the float 303 via the intermediate member 400. As shown in FIGS. 2A and 2B, an outer diameter of the float 303 is larger than an outer diameter of each of the waterproof case 301 and the waterproof case 302. This makes stable the posture of the camera system 500 in the floating state. As described above, in the floating state of the camera system 500, the float 303 creates the buoyant force for positioning one of the first camera 100 and the second camera 200 above the water surface and the other under the water surface. Note that in the state shown in FIG. 2B, out of the first camera 100 and the second camera 200, the first camera 100 is positioned above the water surface, and the second camera 200 is positioned under the water surface, by way of example. Further, the float 303 is in a state sandwiched and held between a ring-shaped rib 301c protrudingly formed along an outer periphery of a portion close to a lower end, as viewed in FIG. 1, of the waterproof case 301 and a ring-shaped rib 302c protrudingly formed along an outer periphery of a portion close to an upper end, as viewed in FIG. 1, of the waterproof case 302.

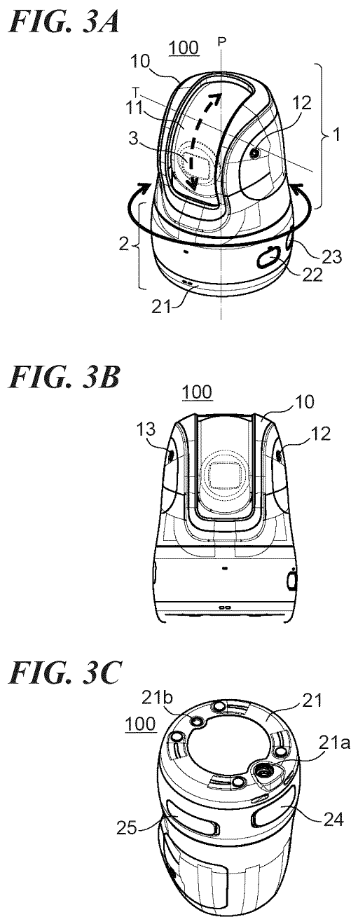

FIGS. 3A to 3C are appearance views of the first camera 100 included in the camera system 500 shown in FIG. 1. FIG. 3A is an appearance perspective view of the first camera 100, as viewed from above in FIG. 1, FIG. 3B is an appearance side view of the first camera 100, and FIG. 3C is an appearance perspective view of the first camera 100, as viewed from below in FIG. 1. As described above, in the present embodiment, the first camera 100 and the second camera 200 are disposed at respective different locations but have the same configuration. As for the camera configuration, the configuration of the first camera 100 will be described as a representative.

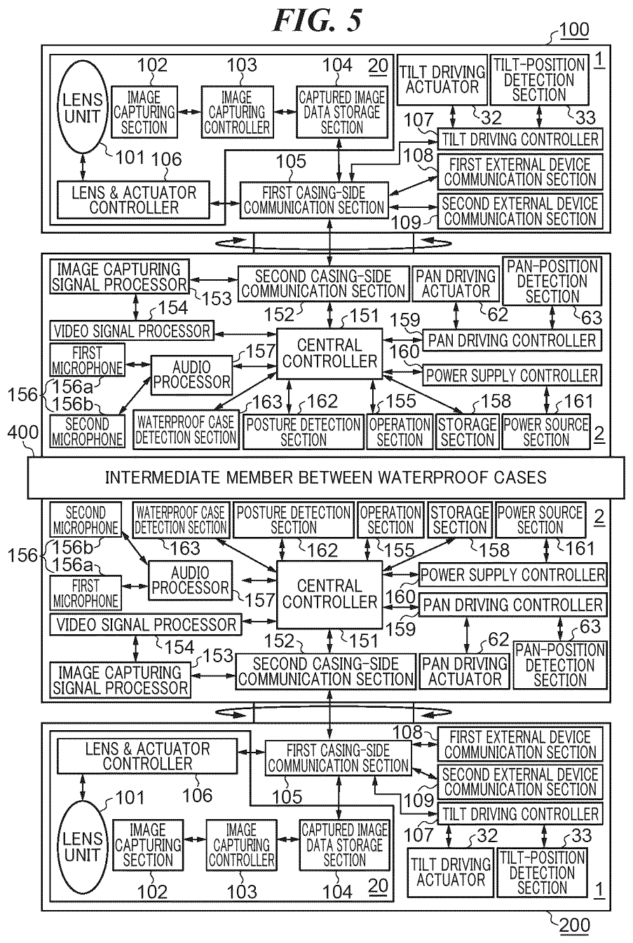

As shown in FIG. 3A, the first camera 100 has a first casing 1 and a second casing 2, which form the exterior of the first camera 100. The first casing 1 is disposed on top of the second casing 2. The first casing 1 is supported on the second casing 2 such that the first casing 1 is rotatable in a horizontal direction (panning direction: direction indicated by a bidirectional solid-line arrow) with respect to the second casing 2, about a rotational axis P extending in a vertical direction. The first casing 1 has a top cover 10 as an exterior component. The top cover 10 has a dome member 11 which covers the front and top sides of the first camera 100. The dome member 11 is transparent enough to enable image capturing using the first camera 100. The material forming the dome member 11 is not particularly limited, but a variety of types of resin materials, such as polycarbonate and acrylic resin, can be used, and in the present embodiment, the acrylic resin having relatively high light transmittance is used. Inside the dome member 11, a lens unit 3 included in the first camera 100 is supported such that the lens unit 3 is rotatable in a vertical direction (tilting direction: direction indicated by a bidirectional broken-line arrow), about a rotational axis T extending in a horizontal direction. The first camera 100 can move the lens unit 3 relative to the second casing 2 by appropriately combining panning rotation (pan rotation) and tilting rotation (tilt rotation). This makes it possible to perform image capturing in a variety of directions even when the first camera 100 is disposed in a fixed position. As shown in FIG. 3B, the top cover 10 is formed with a microphone hole 12 and a microphone hole 13 for collecting sound using a microphone 156 incorporated in the first camera 100 and described hereinafter with reference to FIG. 5. The microphone hole 12 and the microphone hole 13 are disposed symmetrically with respect to the rotational axis P extending in the vertical direction to form a stereo microphone.

The second casing 2 has a bottom cover 21. Inside the bottom cover 21, there are incorporated a camera control circuit board, not shown, on which components described hereinafter with reference to FIG. 5 are mounted, a camera driving battery, not shown, and so forth. As shown in FIG. 3A, on a side surface of the bottom cover 21, there are arranged a power button 22 and a wireless communication button 23 as operation members. By operating the power button 22, the first camera 100 can be switched on or off. By operating the wireless communication button 23, wireless communication with the outside can be switched on or off. As shown in FIG. 3C, on the side surface of the bottom cover 21, there are arranged a media cover 24 and a terminal cover 25. In a state in which the media cover 24 is opened, a card slot (not shown) is exposed. A memory card for recording an image shot by the first camera 100 can be inserted into and removed from the card slot. Further, in a state in which the terminal cover 25 is opened, input and output jacks (not shown) for power supply and signals are exposed. A variety of types of cables can be inserted into and removed from the input and output jacks. Further, a bottom surface of the bottom cover 21 is formed with a fixing screw hole 21a and a positioning hole 21b, which are disposed on opposite sides across the center of the bottom surface. The fixing screw hole 21a is used to fix the first camera 100 to the bottom base 402. The positioning hole 21b is used to position the first camera 100 with respect to the bottom base 402 of the intermediate member 400. Note that the top cover 10 and the bottom cover 21 are each formed of a resin material, such as polycarbonate, which does not shield radio waves for communication.

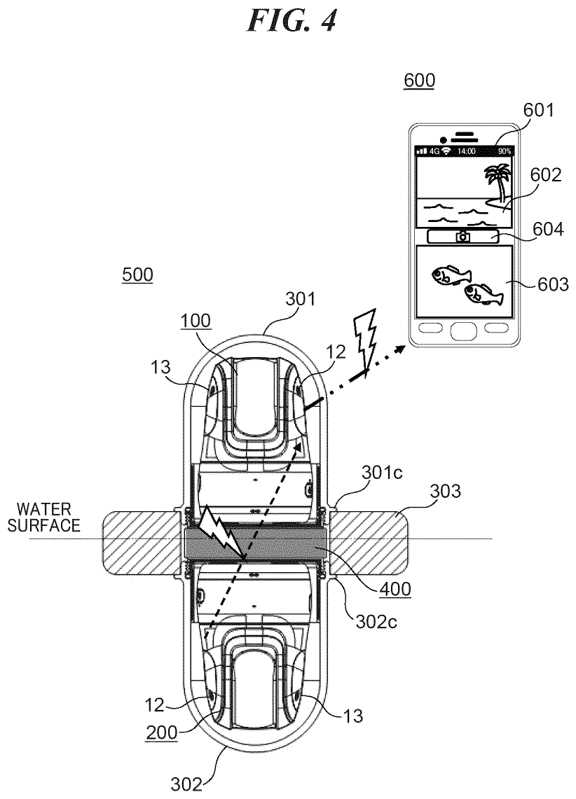

FIG. 4 is a view showing an example of a use state of the camera system 500 shown in FIG. 1. As described above, when the camera system 500 is in the floating state, the first camera 100 and the second camera 200 are positioned vertically symmetrically by the float 303. With this, even when the camera system 500 is inverted upside down e.g. by an influence of waves, the vertically symmetrical positioning of the first camera 100 and the second camera 200 is maintained. This enables each of the first camera 100 and the second camera 200 to cover a range where an image cannot be captured by the other, and as a result, it is possible to expand an image capturing range of the camera system 500 as a whole. As shown in FIG. 4, the camera system 500 is used in combination with a smartphone 600 as an external terminal. For example, when the camera system 500 is in a state in which the first camera 100 is positioned above water, the first camera 100 and the smartphone 600 are mutually communicably connected by an application of the smartphone 600 and a wireless LAN, such as Wi-Fi, as first communication means. This makes it possible to perform data communication for transmitting and receiving a live view image and an input instruction, such as an instruction for starting shooting, between the camera system 500 and the smartphone 600. Note that although the same wireless LAN communication module as that of the first camera 100 is also incorporated in the second camera 200 positioned under water, radio waves of the wireless LAN cannot be propagated in water, and hence the second camera 200 cannot perform wireless communication with the smartphone 600. The waterproof case 301 and the waterproof case 302 prevent the first camera 100 and the second camera 200 from being affected by water, respectively, and hence the first camera 100 and the second camera 200 are wirelessly communicably connected to each other. In the present embodiment, the first camera 100 and the second camera 200 are wirelessly connected via a Bluetooth communication module as second communication means. Further, in the use state of the camera system 500 shown in FIG. 4, the first camera 100 is set as “the leader”, and the second camera 200 is set as “the follower”. With this, the live view image captured by the second camera 200 is transmitted to the smartphone 600 by the Wi-Fi communication of the first camera 100, together with the live view image captured by the first camera 100.

On a screen 601 of the smartphone 600, an above-water live view image 602 captured by the first camera 100 and an underwater live view image 603 captured by the second camera 200 are displayed in the upper and lower parts of the screen 601, respectively. Further, on the screen 601, an icon 604 which enables a user to input an instruction for starting or stopping shooting of a still image or a moving image is also displayed between the above-water live view image 602 and the underwater live view image 603. This enables the user to start and stop shooting of a still image or a moving image at a desired timing while viewing each live view image. As described above, the first camera 100 and the second camera 200 are arranged such that the first camera 100 and the second camera 200 are vertically inverted from each other. For this reason, the first camera 100 and the second camera 200 each have the microphone hole 12 and microphone hole 13, positioned opposite to each other in the left-right direction. Therefore, it is preferable to record audio signals input to the microphone of the second camera 200 by reversing the left and right of sound of the audio signals by signal processing. With this processing, when a moving image is reproduced, the left-right direction of the image and the left-right direction of the sound source match each other, and the user can view the moving image without feeling strange when hearing the reproduced sound. Note that the term “image capturing” is used to mean capturing an optical image acquired by the lens unit 101 as image data, whereas the term “shooting” is used to mean “image capturing” performed assuming that the captured image data is recorded. In other words, shooting includes permanently recording image data acquired by image capturing.

FIG. 5 is a block diagram showing a hardware configuration of the camera system shown in FIG. 1. The first camera 100 and the second camera 200 have the same configuration, and hence the components of the first camera 100 and the second camera 200 are denoted by the same reference numerals in FIG. 5. First, the internal configuration of the first casing 1 will be described. As shown in FIG. 5, the first casing 1 incorporates a lens unit (image capturing optical system) 101, an image capturing section 102, an image capturing controller 103, a captured image data storage section 104, a first casing-side communication section 105, and a lens-and-actuator controller 106. The components incorporated in the first casing 1 form a tilt unit 20. Further, the first casing 1 incorporates a tilt driving controller 107, a first external device communication section 108, a second external device communication section 109, a tilt driving actuator 32, and a tilt-position detection section 33.

The lens unit 101 includes e.g. holders for holding a plurality of lenses, respectively, a zoom lens mechanism, a diaphragm-and-shutter unit, and an auto-focus unit. The image capturing section 102 includes an image capturing device, such as a CMOS sensor or CCD sensor, for capturing an image, and outputs electrical signals (image signals) by photoelectrically converting an optical image (object image) formed by the lens unit 101. The image capturing section 102 in the first camera 100 forms the first image capturing section and the image capturing section 102 in the second camera 200 forms the second image capturing section. The image capturing controller 103 processes the electrical signals output from the image capturing section 102 to desired image data and stores the processed image data in the captured image data storage section 104. Further, the image capturing controller 103 transfers the image data (captured image data) stored in the captured image data storage section 104 to the first casing-side communication section (wireless communication section) 105. The first casing-side communication section 105 includes a transmission and reception antenna and is capable of performing data communication between the first casing 1 and the second casing 2, and receiving electric power from the second casing 2 by wireless communication. The lens-and-actuator controller 106 includes a motor driver IC and controls driving of a variety of actuators e.g. for the zoom lens mechanism, the diaphragm-and-shutter unit, and the auto-focus unit of the lens unit 101.

The tilt driving controller 107 drives the tilt unit 20 for tilting by appropriately controlling driving of the tilt driving actuator 32 based on a result of detection performed by the tilt-position detection section 33. The tilt-position detection section 33 is comprised of an optical sensor and functions as a tilt rotational position detection section of the tilt unit 20 in combination with a reflection scale provided in the tilt unit 20. Note that the variety of actuators and sensors are drivingly controlled based on driving instruction information received by the first casing-side communication section 105. The first external device communication section 108 is a wireless LAN communication module, such as Wi-Fi, and is capable of performing communication between the first camera 100 and an external device, such as the smartphone 600. The first external device communication section 108 is capable of transmitting and receiving e.g. audio signals (audio data), image signals (image data), compressed audio signals (compressed audio data), and compressed image signals (compressed image data). The first external device communication section 108 is provided in both of the first camera 100 (first image capturing section) and the second camera 200 (second image capturing section). Further, the first external device communication section 108 of one of these cameras, which is positioned above the water surface in the floating state of the camera system 500, performs transmission and reception of data. Therefore, the first external device communication section 108 has functions of a transmission section and a reception section. Further, the first external device communication section 108 is capable of transmitting and receiving data, such as an instruction for starting or terminating shooting and an instruction for enlarging or reducing an object according to a zooming operation. Further, the first external device communication section 108 receives control signals related to image capturing, such as a command for starting or terminating shooting, signals for panning driving and tilting driving, and a signal for zoom driving, from the smartphone 600. The second external device communication section 109 is a wireless communication module, such as a Bluetooth communication module, and is capable of transmitting and receiving control signals for performing multi-camera simultaneous image capturing and the like in combination with another camera having the similar configuration, and data. Note that although the first external device communication section 108 and the second external device communication section 109 are disposed in the first casing 1 in the present embodiment, this is not limitative, but for example, the first external device communication section 108 and the second external device communication section 109 may be disposed in the second casing 2 or may be disposed such that they are distributed in the first casing 1 and the second casing 2, respectively.

Next, the internal configuration of the second casing 2 will be described. The second casing 2 incorporates a central controller (controller) 151, a second casing-side communication section (wireless communication section) 152, an image capturing signal processor 153, a video signal processor 154, an operation section 155, the microphone (audio input section) 156, and an audio processor 157. Further, the second casing 2 incorporates a storage section 158, a pan driving controller 159, a power supply controller 160, a power source section 161, a posture detection section (detection section) 162, a waterproof case detection section 163, and a pan-position detection section 63.

The central controller 151 is a computer having a central processing unit (CPU). The central controller 151 is provided in both of the first camera 100 and the second camera 200. The central controller 151 of the first camera 100 controls the entirety of the first camera 100, including the image capturing section 102 of the first camera 100, and the central controller 151 of the second camera 200 controls the entirety of the second camera 200, including the image capturing section 102 of the second camera 200. The second casing-side communication section 152 performs data communication between the first casing 1 and the second casing 2 by wireless communication, such as reception of image data (captured image data) from the first casing 1, and transmission of driving instruction signals for the variety of actuators and sensors within the first casing 1. Further, the second casing-side communication section 152 transmits electric power to the first casing 1 based on an instruction from the central controller 151. The image capturing signal processor 153 converts electrical signals (image capturing signals) output from the image capturing section 102 via the second casing-side communication section 152 to video signals. The video signal processor 154 processes the video signals output from the image capturing signal processor 153 to desired image data according to its use. Processing of the video signals includes an electronic anti-vibration operation by image cutout and image rotation. The operation section 155 receives a user operation. To the microphone 156 of the first camera 100, sound around the first camera 100 is input and the sound is acquired as audio signals (audio data). Further, to the microphone 156 of the second camera 200, sound around the second camera 200 is input and the sound is acquired as audio signals. Each microphone 156 transmits the audio signals to the audio processor 157 after converting the signals from analog to digital e.g. via an amplifier. Further, each microphone 156 is formed by a pair of a first microphone 156a and a second microphone 156b and is capable of performing stereo recording. The audio processor 157 performs processing on sound, such as processing for optimizing input digital audio signals. Then, the audio signals processed by the audio processor 157 are transmitted to the storage section 158 by the central processor 151 and transmitted to the smartphone 600 from the first external device communication section 108.

The storage section 158 stores a variety of types of data, such as video signals and audio signals obtained by the video signal processor 154 and the audio processor 157, respectively. Further, the storage section 158 stores programs for causing the central controller 151 to execute a method of controlling the components of the camera system 500 (method of controlling the image capturing apparatus). The pan driving controller 159 drives the first casing 1 for panning, by appropriately controlling driving of a pan driving actuator 62 based on a result of detection performed by the pan-position detection section 63. The pan-position detection section 63 is comprised of an optical sensor and functions as a panning rotational position detection section of the first casing 1 in combination with a reflection scale provided in the first casing 1. The posture detection section 162 detects a vertical direction of the camera system 500 in the floating state, and by this detection, in the present embodiment, it is possible to detect a posture and a state of the second casing 2. As the posture detection section 162, an acceleration sensor and a gyro sensor, for example, can be used. With this, the posture detection section 162 can detect a posture of the second casing 2 based on a gravity direction. Note that although in the present embodiment, the posture detection section 162 is disposed in the second casing 2, this is not limitative, but, for example, the posture detection section 162 may be disposed in the first casing 1 or may be disposed in both of the first casing 1 and the second casing 2. The power supply controller 160 is comprised of a battery detection circuit, a DC-DC converter, and a switch circuit for switching blocks to be energized, and detects whether or not a battery is attached, a type of the battery, and a remaining amount of the battery. Further, the power supply controller 160 controls the DC-DC converter to supply a necessary amount of electric power to each component for a necessary time period based on a result of detection by the power supply controller 160 itself and an instruction from the central controller 151. The power source section 161 is comprised of a primary battery, such as an alkaline battery or a lithium battery, or a secondary battery, such as a NiCd battery, a NiMH battery, or a Li battery, and an AC adapter. The power source section 161 and the power supply controller 160 are electrically connected by a camera-side power supply connector and a power supply connector. The waterproof case detection section 163 of the first camera 100 is disposed in the vicinity of the bottom of the first camera 100 and detects attachment of the waterproof case 301 over the first camera 100. Further, the waterproof case detection section 163 of the second camera 200 is disposed in the vicinity of the bottom of the second camera 200 and detects attachment of the waterproof case 302 over the second camera 200. Each waterproof case detection section 163 has a Hall element that detects a magnetic force of a magnet (not shown) embedded in e.g. the waterproof case 301 or the waterproof case 302.

Note that although in the present embodiment, the wireless power supply mechanism is formed between the first casing 1 and the second casing 2, and electric power is supplied from the second casing 2 to the first casing 1, this is not limitative. For example, wires, electrical contacts, and the like, may be used to supply electric power. For example, the components in the first casing 1 may be operated by electric power supplied from a power source section provided in the first casing 1. Further, transmission of data, such as control signals and image signals, from the second casing 2 to the first casing 1 is not limited to transmission by wireless communication but may be performed e.g. by wired communication.

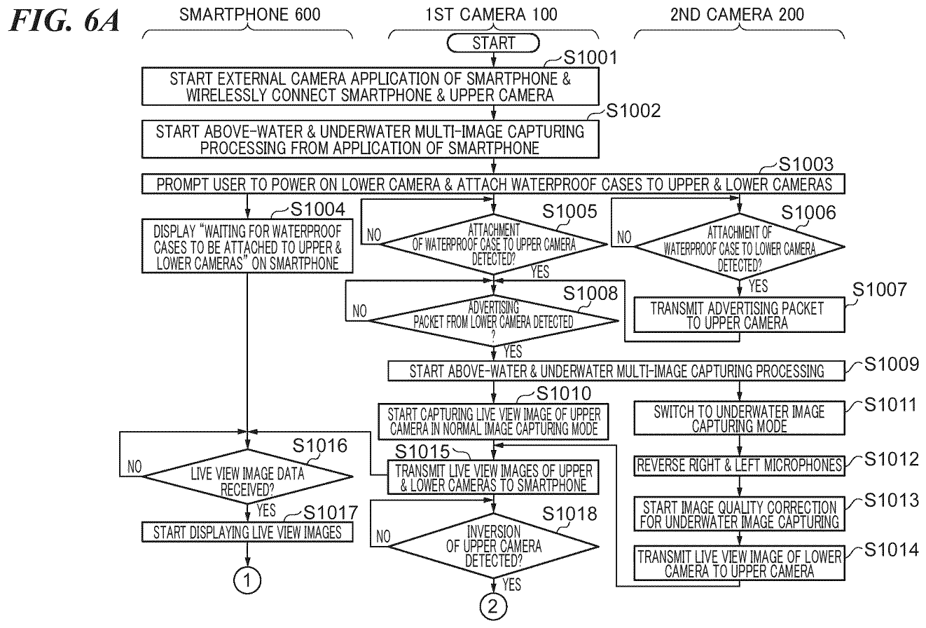

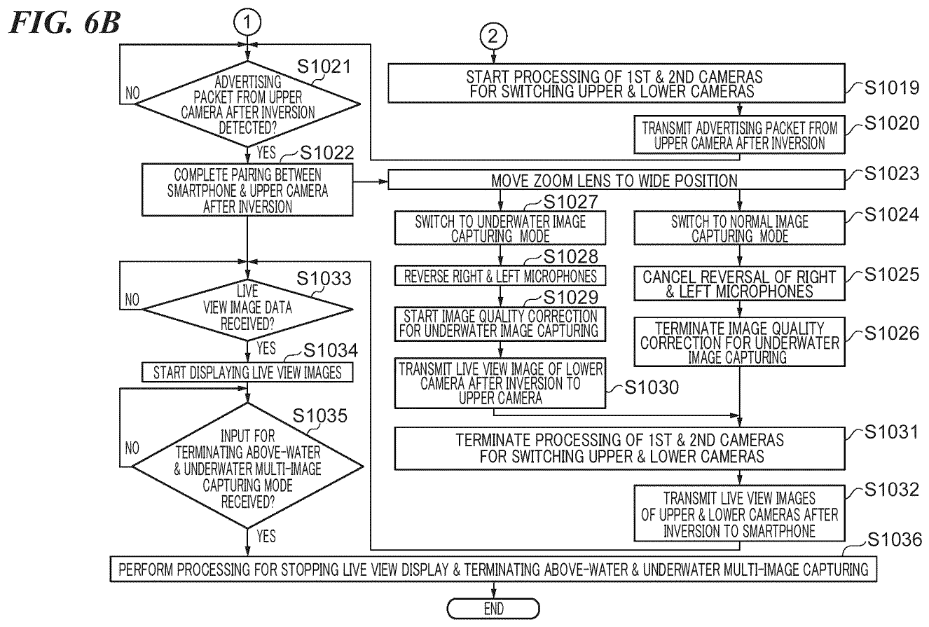

FIGS. 6A and 6B are a flowchart of a process performed by the camera system shown in FIG. 1. In the following description, it is assumed that at first the first camera 100 and the second camera 200 of the camera system 500 are in respective vertical positions shown in FIG. 1, and accordingly the first camera 100 is set as “the leader” which is “the upper camera” defined as a camera that performs above-water image capturing, and the second camera 200 is set as the “follower” which is “the lower camera” defined as a camera that performs underwater image capturing. In this case, the camera which can wirelessly communicate with the smartphone 600 is the first camera 100 which is “the upper camera” positioned above water and is not affected by water. As described hereinafter, when the camera system 500 is in a floating state in which the positions of the first camera 100 and the second camera 200 are vertically inverted upside down from those shown in FIG. 1, the second camera 200 is set as the leader which is the upper camera that performs above-water image capturing, and the first camera 100 is set as the follower which is the lower camera that performs underwater image capturing.

Referring to FIG. 6A, in a step S1001, the user starts an external camera application of the smartphone 600, powers on the first camera 100, in its position shown in FIG. 1, of the camera system 500 by an instruction from a screen of the application, and operates the wireless communication button 23. This makes it possible to wirelessly connect the smartphone 600 and the first camera 100 by Wi-Fi communication. Then, the process proceeds to a step S1002.

In the step S1002, the user starts an above-water and underwater multi-image capturing mode using the above-mentioned application, and the process proceeds to a step S1003.

In the step S1003, the smartphone 600 displays an instruction message “Power on the second camera 200” and an instruction message “Attach the waterproof case 301 and the waterproof case 302”, on the screen 601. Then, the process proceeds to a step S1004. According to the display in the step S1003, the user can power on the second camera 200 and attach the waterproof case 301 and the waterproof case 302.

In the step S1004, the smartphone 600 displays a message to the effect that “The camera system 500 is in a state waiting for the waterproof case 301 and the waterproof case 302 to be attached to the first camera 100 and the second camera 200, respectively” on the screen 601, and the process proceeds to a step S1016.

Further, after execution of the step S1003, in a step S1005, the central controller 151 of the first camera 100 determines whether or not the waterproof case 301 has been attached, based on a result of the detection performed by the waterproof case detection section 163. If it is determined in the step S1005 that the waterproof case 301 has been attached, the process waits until steps S1006 and S1007 are completed, and then proceeds to a step S1008. On the other hand, if it is determined in the step S1005 that the waterproof case 301 has not been attached, the process repeats the step S1005.

In a step S1006, the central controller 151 of the second camera 200 (lower camera) determines whether or not the waterproof case 302 has been attached, based on a result of the detection performed by the waterproof case detection section 163. If it is determined in the step S1006 that the waterproof case 302 has been attached, the process proceeds to a step S1007. On the other hand, if it is determined in the step S1006 that the waterproof case 302 has not been attached, the process repeats the step S1006.

In the step S1007, the central controller 151 of the second camera 200 performs wireless connection to the first camera 100 via the Bluetooth communication module and transmits an advertising packet to the first camera 100, and the process proceeds to the step S1008.

In the step S1008, the central controller 151 of the first camera 100 performs wireless connection to the second camera 200 via the Bluetooth communication module and determines whether or not the advertising packet from the second camera 200 has been detected (received). If it is determined in the step S1008 that the advertising packet has been detected, the process proceeds to a step S1009. On the other hand, if it is determined in the step S1008 that the advertising packet has not been detected, the process repeats the step S1008.

In the step S1009, wireless connection is established between the first camera 100 and the second camera 200, and Bluetooth communication is enabled in both of them, whereafter the process proceeds to a step S1010. In the step S1009, the first camera 100 is connected as the leader and the second camera 200 is connected as the follower. The first camera 100 is set as the leader because the first camera 100 is the upper camera positioned above water and hence the first camera 100 is hard to be affected by water in wireless connection to the smartphone 600.

In the step S1010, the central controller 151 of the first camera 100 starts capturing a live view image in a normal image capturing mode (first image capturing mode). The “normal image capturing mode” is an image capturing mode suitable for image capturing above the water surface (above-water image capturing), and more specifically, a mode in which execution of steps S1012 and S1013, described hereinafter, is omitted.

Further, after execution of the step S1009, in a step S1011, the central controller 151 of the second camera 200 changes, for capturing a live view image, the image capturing mode from the normal image capturing mode to an underwater image capturing mode (second image capturing mode), and the process proceeds to the step S1012. The “underwater image capturing mode” is an image capturing mode suitable for image capturing under the water surface (underwater image capturing), and more specifically, a mode in which the steps S1012 and S1013 are executed. In the camera system 500, the vertical direction of the camera system 500 in the floating state can be detected by the posture detection section 162 of the second camera 200. With this, the central controller 151 of the second camera 200 can recognize the second camera 200 as the lower camera. Further, the central controller 151 of the first camera 100 can recognize the image capturing mode of the second camera 200 as the underwater image capturing mode by the Bluetooth communication connection to the second camera 200.

In the step S1012, the central controller 151 of the second camera 200 reverses the left and right of sound of the audio signals input from the first microphone 156a and the second microphone 156b of the second camera 200, by signal processing, and the process proceeds to the step S1013. As described above with reference to FIG. 4, the reversal of the left and right of sound of the audio signals is performed so as to cause the left-right diction of the sound source and the left-right direction of the image to match each other when the moving image captured by the second camera 200 is reproduced.

In the step S1013, the central controller 151 of the second camera 200 starts image quality correction for underwater image capturing, and the process proceeds to a step S1014. In the underwater image capturing, compared with the above-water image capturing, which is normal, a red component of color is absorbed and attenuated, so that a bluish image is obtained. For this reason, in the image quality correction for underwater image capturing in the step S1013, the red color is emphasized.

In the step S1014, the central controller 151 of the second camera 200 transmits the live view image being captured by the second camera 200 to the first camera 100 by Bluetooth communication, and the process proceeds to a step S1015.

In the step S1015, the central controller 151 of the first camera 100 transmits the live view image being captured by the first camera 100 and the live view image being captured by the second camera 200 to the smartphone 600 by wireless communication, and the process proceeds to a step S1016.

In the step S1016, the smartphone 600 determines whether or not data of the live view images, transmitted in the step S1015, has been received. If it is determined in the step S1016 that the data has been received, the process proceeds to a step S1017. On the other hand, if it is determined in the step S1016 that the data has not been received, the process repeats the step S1016.

In the step S1017, the smartphone 600 starts displaying the live view images received in the step S1016 on the screen 601. With this, the user is enabled to give an instruction for starting shooting at a desired timing while viewing the live view images. Note that the instruction for starting shooting is not limited to a user's instruction. For example, shooting may be automatically started at a timing at which a main object set in advance is detected from the live view images. Further, shooting may be started at a timing at which the input of sound is increased.

In the camera system 500, in the data of a captured image (regardless of whether the captured image is a still image or a moving image), there is written information on a vertical positional relationship between the first camera 100 and the second camera 200, i.e. whether the camera system 500 is in a posture with a vertically normal positional relationship between the first camera 100 and the second camera 200 or in a posture with a vertically inverted positional relationship therebetween. With this, when reproducing a captured image, it is possible to select an image captured by the first camera 100 or an image captured by the second camera 200 and display the selected image. This makes it possible to reproduce e.g. only an underwater image, which increases the convenience of a user when searching for an image or viewing an image. Further, by writing in the image data not only the information on a posture, but also information on whether image capturing has been performed in the normal image capturing mode or in the underwater image capturing mode, it is possible to obtain the same advantageous effects provided by the above-mentioned image selection.

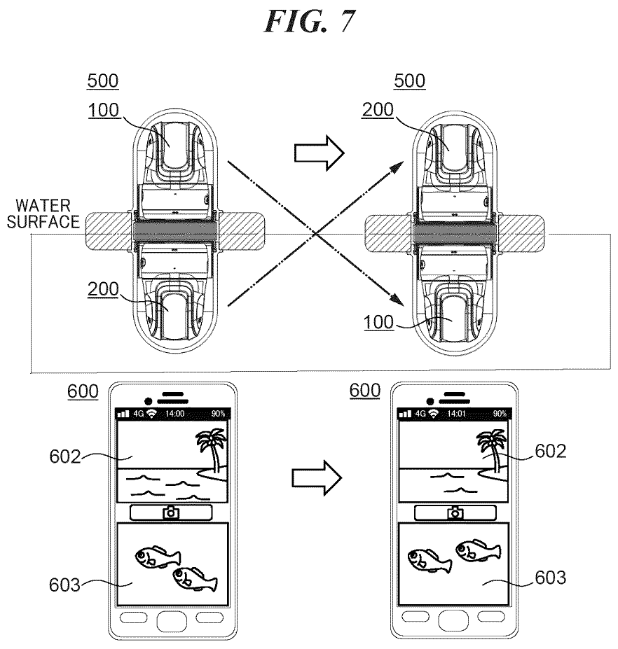

Next, a case where the positional relationship between the upper and lower cameras is inverted e.g. by waves during the above-water and underwater multi-image capturing, i.e. a case where the camera system 500 is inverted upside down will be described with reference to FIG. 7. FIG. 7 is a diagram showing a relationship between images captured by the camera system 500 shown in FIG. 1 and images displayed on the smartphone 600. In a floating state shown in the left half part of FIG. 7, the first camera 100 is the upper camera positioned above water, and the second camera 200 is the lower camera positioned under water. On the other hand, in a floating state shown in the right half part of FIG. 7, the second camera 200 is the upper camera positioned above water, and the first camera 100 is the lower camera positioned under water. Inversion of the upper and lower cameras refers to a change of the camera system 500 from the state shown in the left half part of FIG. 7 to the state shown in the right half part of FIG. 7. Note that immediately after the upper and lower cameras have been inverted, wireless connection between the first camera 100 of the camera system 500 and the smartphone 600 is disconnected by the influence of water, and the smartphone 600 is temporarily placed in a wireless connection-waiting state. However, by executing a step S1018 et seq., described hereinafter, wireless connection between the camera system 500 and the smartphone 600 is restored, and the underwater image capturing mode and the normal image capturing mode are switched in each of the upper and lower cameras. Note that the Bluetooth connection between the upper and lower cameras is continued even after the camera system 500 is inverted upside down.

As shown in FIG. 6A, after execution of the step S1015, in the step S1018, the central controller 151 of the first camera 100 as the upper camera determines whether or not the first camera 100 has been inverted upside down based on a result of the detection performed by the posture detection section 162. If it is determined in the step S1018 that the first camera 100 has been inverted upside down, the process proceeds to a step S1019 in FIG. 6B. On the other hand, if it is determined in the step S1018 that the first camera 100 has not been inverted upside down, the process repeats the step S1018. Note that in the step S1018, the central controller 151 of the first camera 100 may determine whether or not the first camera 100 has been inverted upside down based not only on the above-mentioned detection result, but also on a result of the detection performed by the posture detection section 162 of the second camera 200.

In the step S1019 in FIG. 6B, the central controller 151 of the first camera 100 starts processing for switching the first camera 100 from the upper camera to the lower camera, and the central controller 151 of the second camera 200 starts processing for switching the second camera 200 from the lower camera to the upper camera, whereafter the process proceeds to a step S1020.

In the step S1020, the central controller 151 of the second camera 200 which has become the upper camera after inversion performs wireless connection to the smartphone 600 and transmits an advertising packet to the smartphone 600, and the process proceeds to a step S1021.

In the step S1021, the smartphone 600 determines whether or not the advertising packet from the second camera 200 as the upper camera has been detected (received). If it is determined in the step S1021 that the advertising packet has been detected, the process proceeds to a step S1022. On the other hand, if it is determined in the step S1021 that the advertising packet has not been detected, the process repeats the step S1021.

In the step S1022, the smartphone 600 is placed in a wirelessly connected state by completing paring with the second camera 200 as the upper camera, and the process proceeds to a step S1023. Further, immediately before execution of the step S1022, the relationship between the first camera 100 and the second camera 200 in respect of the leader and the follower is reversed. That is, the second camera 200 as the upper camera becomes the leader, and the first camera 100 as the lower camera becomes the follower.

In the step S1023, in the second camera 200 camera and the first camera 100, which have been changed to the upper camera and the lower camera, respectively, by the inversion, each central controller 151 moves the zoom lens to a wide position on the wide-angle side, and the process proceeds to a step S1024 for the second camera 200 and a step S1027 for the first camera 100. By executing the step S1023, it is possible to reset a zooming operation performed immediately before the upside-down inversion to the wide-angle side, when the cameras are inverted upside down. With this, each live view image is changed to one enabling the user to view a wide range, so that it is possible to easily find a main object by user's visual observation or for automatic shooting.

In the step S1024, the central controller 151 of the second camera 200 changes the image capturing mode of the second camera 200 from the underwater image capturing mode before inversion to the normal image capturing mode, and the process proceeds to a step S1025.

In the step S1025, the central controller 151 of the second camera 200 cancels the processing for reversing the left and right of sound of the audio signals in the step S1012, and the process proceeds to a step S1026.

In the step S1026, the central controller 151 of the second camera 200 terminates image quality correction for underwater image capturing started in the step S1013, and the process waits until a step S1030, described hereinafter, is completed.

Further, after execution of the step S1023, in the step S1027, the central controller 151 of the first camera 100 as the lower camera changes the image capturing mode of the first camera 100 from the normal image capturing mode before inversion to the underwater image capturing mode, and the process proceeds to a step S1028.

In the step S1028, the central controller 151 of the second camera 100 reverses the left and right of sound of the audio signals input from the first microphone 156a and the second microphone 156b of the first camera 100, by signal processing, and the process proceeds to a step S1029.

In the step S1029, the central controller 151 of the first camera 100 starts image quality correction for underwater image capturing, and the process proceeds to the step S1030.

In the step S1030, the central controller 151 of the first camera 100 as the lower camera after inversion transmits the live view image being captured by the first camera 100 to the second camera 200 by Bluetooth communication, and the process proceeds to a step S1031.

In the step S1031, the processing for switching between the upper camera and the lower camera is terminated, and the process proceeds to a step S1032.

In the step S1032, the central controller 151 of the second camera 200 as the upper camera after inversion transmits the live view image being captured by the first camera 100 and the live view image being captured by the second camera 200 to the smartphone 600 by wireless communication, and the process proceeds to a step S1033.

In the step S1033, the smartphone 600 determines whether or not data of the live view images transmitted in the step S1032 has been received. If it is determined in the step S1033 that the data has been received, the process proceeds to a step S1034. On the other hand, if it is determined in the step S1033 that the data has not been received, the process repeats the step S1033.

In the step S1034, the smartphone 600 starts displaying the live view images received in the step S1033 on the screen 601. On the smartphone 600 before the camera system 500 is inverted upside down, as shown in the left half part of FIG. 7, the above-water live view image 602 captured by the first camera 100 and the underwater live view image 603 captured by the second camera 200 are displayed. Then, on the smartphone 600 after the camera system 500 has been inverted upside down, as shown in the right half part of FIG. 7, by executing the step S1034, the above-water live view image 602 captured by the second camera 200 and the underwater live view image 603 captured by the first camera 100 are displayed. This makes it possible to omit the complicated operation for switching the live view images, which would otherwise be required to be performed by the user whenever the camera system 500 is inverted upside down, thereby improving the user's convenience.

In a step S1035, the smartphone 600 determines whether or not an input for terminating the above-water and underwater multi-image capturing mode has been performed by the user. If it is determined in the step S1035 that the input has been performed, the process proceeds to a step S1036. On the other hand, if it is determined in the step S1035 that the input has not been performed, the process repeats the step S1035.

In the step S1036, the smartphone 600 transmits an instruction for stopping transmission of the live view images and an instruction for terminating the above-water and underwater multi-image capturing to the second camera 200, followed by terminating the present process.

As described above, in the camera system 500, the vertical direction of the camera system 500 is detected based on a result of the detection performed by the posture detection section 162 and a result of communication between the first camera 100 and the second camera 200. By this detection, which of the first camera 100 and the second camera 200 is positioned above the water surface, and which of them is positioned under the water surface are determined. Then, in the camera system 500, out of the first camera 100 and the second camera 200, one positioned above the water surface is set as the upper camera, and the image capturing mode of this camera is changed to the normal image capturing mode, whereas one positioned under the water surface is set as the lower camera, and the image capturing mode of this camera is changed to the underwater image capturing mode. Thus, the camera system 500 can automatically switch, for each of the first camera 100 and the second camera 200, between the normal image capturing mode suitable for image capturing above the water surface (above-water image capturing) and the underwater image capturing mode suitable for image capturing under the water surface (underwater image capturing), as required. Further, the camera system 500 can transmit image data captured in the normal image capturing mode (hereinafter referred to as the “first image data”) and image data captured in the underwater image capturing mode (hereinafter referred to as the “second image data”) to the smartphone 600. This enables the user to view the above-water live view image 602 based on the first image data and the underwater live view image 603 based on the second image data, on the smartphone 600.

Further, in the camera system 500, the normal image capturing mode and the underwater image capturing mode can be switched as required in a state in which the waterproof case 301 and the waterproof case 302 are attached. This makes it possible to prevent image capturing in the underwater image capturing mode from being performed in a state in which the waterproof case 301 and the waterproof case 302 are not attached.

Further, the first image data includes first position information of the upper camera, obtained when the first image data is captured. The second image data includes second position information of the lower camera, obtained when the second image data is captured. This makes it possible to determine which of the cameras has captured the first image data or the second image data, based on the first position information and the second position information.

Further, in the camera system 500, the left and right of sound of the audio signals input from the first microphone 156a and the second microphone 156b are reversed between the normal image capturing mode and the underwater image capturing mode, by signal processing. With this, the left-right direction of the image and the left-right direction of the sound source match each other when a moving image is reproduced, and the user can view the moving image without a feeling of strangeness.

Further, in the camera system 500, an image capturing instruction provided e.g. from the smartphone 600 via the application is not necessarily required for the above-water and underwater multi-image capturing mode. For example, the camera system 500 may start the above-water and underwater multi-image capturing mode, when the user long-presses the wireless communication buttons of the upper and lower cameras in a state in which attachment of the waterproof case 301 and the waterproof case 302 is detected and paring of these cameras is completed. Further, an image capturing time in the above-water and underwater multi-image capturing mode may be set. Further, the camera system 500 may shoot a still image or a moving image when a feature image, such as face information, registered in advance is detected. Further, in the camera system 500, the upper camera and the lower camera may automatically search for a main object using the panning-and-tilting mechanisms, the zoom lens mechanisms, and so forth, start automatic tracking after the main object is detected, and then shoot a still image or a moving image.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disc (such as a compact disc (CD), digital versatile disc (DVD), or Blu-ray Disc (BD)™), a flash memory device, a memory card, and the like.

Further, although the image capturing section 102 is configured to be capable of rotating in both of the panning direction and the tilting direction in the above-described embodiment, this is not limitative, but for example, the image capturing section 102 may be supported such that the image capturing section 102 is rotatable in one of the panning direction and the tilting direction. Further, the image capturing section 102 may be restricted in rotation, i.e. may be fixed. Further, although communication between the first camera 100 and the second camera 200 is performed by wireless communication in the above-described embodiment, this is not limitative, but for example, the communication may be performed by wired communication.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-111294 filed Jul. 11, 2022, which is hereby incorporated by reference herein in its entirety.

What is claimed is:

1. An image capturing apparatus that is used for image capturing in a floating state in which the image capturing apparatus floats on a water surface, comprising:
a first image capturing section configured to capture an image;
a second image capturing section configured to capture an image;
a float configured to create a buoyant force for positioning, out of the first image capturing section and the second image capturing section, one image capturing section above the water surface and the other image capturing section under the water surface, when the image capturing apparatus is in the floating state;
a detection section configured to detect a vertical direction of the image capturing apparatus in the floating state; and
a controller configured to control the first image capturing section and the second image capturing section,
wherein the controller switches, out of the first image capturing section and the second image capturing section, the one image capturing section positioned above the water surface to a first image capturing mode suitable for image capturing above the water surface, and the other image capturing section positioned under the water surface to a second image capturing mode suitable for image capturing under the water surface, based on a result of detection performed by the detection section.

2. The image capturing apparatus according to claim 1, wherein the first image capturing section and the second image capturing section are mutually communicably connected, and
wherein the controller determines, by detection of the vertical direction based on the result of the detection performed by the detection section and a result of communication between the first image capturing section and the second image capturing section, which of the first image capturing section and the second image capturing section is positioned above the water surface and which of the first image capturing section and the second image capturing section is positioned under the water surface.

3. The image capturing apparatus according to claim 1, further comprising:
a first waterproof case for housing the first image capturing section, and
a second waterproof case for housing the second image capturing section, and
wherein the float is disposed between the first waterproof case and the second waterproof case.

4. The image capturing apparatus according to claim 3, wherein the first waterproof case and the second waterproof case are removably attached to the float, and
wherein the controller is capable of switching between the first image capturing mode and the second image capturing mode, in a state in which the first waterproof case and the second waterproof case have been attached.

5. The image capturing apparatus according to claim 1, further comprising a transmission section configured to transmit first image data captured in the first image capturing mode and second image data captured in the second image capturing mode.

6. The image capturing apparatus according to claim 5, wherein the transmission section is provided in both of the first image capturing section and the second image capturing section, and
wherein the first image data and the second image data are transmitted from the transmission section provided in the one image capturing section positioned above the water surface, out of the first image capturing section and the second image capturing section.

7. The image capturing apparatus according to claim 5, wherein the first image data includes first position information of the one image capturing section, which is obtained when the first image data is captured, and
wherein the second image data includes second position information of the other image capturing section, which is obtained when the second image data is captured.

8. The image capturing apparatus according to claim 1, further comprising a pair of audio input sections which are controlled by the controller and to which sound is input, and
wherein the pair of audio input sections are provided in both of the first image capturing section and the second image capturing section, and
wherein the controller reverses the left and right of sound of audio signals input from the pair of audio input sections between the first image capturing mode and the second image capturing mode.

9. The image capturing apparatus according to claim 8, further comprising a transmission section configured to transmit the audio signals input from the pair of audio input sections as data.

10. The image capturing apparatus according to claim 1, wherein the first image capturing section and the second image capturing section are arranged symmetrically with respect to the float.

11. A method of controlling an image capturing apparatus that is used for image capturing in a floating state in which the image capturing apparatus floats on a water surface, the image capturing apparatus including:
a first image capturing section configured to capture an image,
a second image capturing section configured to capture an image,
a float configured to create a buoyant force for positioning, out of the first image capturing section and the second image capturing section, one image capturing section above the water surface and the other image capturing section under the water surface, when the image capturing apparatus is in the floating state,
a detection section configured to detect a vertical direction of the image capturing apparatus in the floating state, and
a controller configured to control the first image capturing section and the second image capturing section,
the method comprising:
switching, by control of the controller, out of the first image capturing section and the second image capturing section, the one image capturing section positioned above the water surface to a first image capturing mode suitable for image capturing above the water surface, and the other image capturing section positioned under the water surface to a second image capturing mode suitable for image capturing under the water surface, based on a result of detection performed by the detection section.

12. A non-transitory computer-readable storage medium storing a program for causing a computer to execute a method of controlling an image capturing apparatus that is used for image capturing in a floating state in which the image capturing apparatus floats on a water surface, the image capturing apparatus including:
a first image capturing section configured to capture an image,
a second image capturing section configured to capture an image,
a float configured to create a buoyant force for positioning, out of the first image capturing section and the second image capturing section, one image capturing section above the water surface and the other image capturing section under the water surface, when the image capturing apparatus is in the floating state,
a detection section configured to detect a vertical direction of the image capturing apparatus in the floating state, and
a controller configured to control the first image capturing section and the second image capturing section,
wherein the method comprises:
switching, by control of the controller, out of the first image capturing section and the second image capturing section, the one image capturing section positioned above the water surface to a first image capturing mode suitable for image capturing above the water surface, and the other image capturing section positioned under the water surface to a second image capturing mode suitable for image capturing under the water surface, based on a result of detection performed by the detection section.
